(19) United States
(12) Patent Application Publication
(10) Pub. No.: US 2004/0192188 A1
(43) Pub. Date: Sep. 30, 2004

(54) Test procedure for use of personal mobile user equipment in an aircraft environment

(76) Inventor: Michael Dieudonne, Rhode St Genese (BE)

Correspondence Address: PERMAN & GREEN, 425 POST ROAD, FAIRFIELD, CT, 06824, US

(21) Appl. No.: 10/766,617

(22) Filed: Jan. 27, 2004

(30) Foreign Application Priority Data
Feb. 1, 2003 (GB) 0302329.8

(51) Int. Cl. H04B 3/36; H04Q 7/20

(52) U.S. Cl. 455/3.01; 455/431; 455/7

(57) ABSTRACT

The present invention relates to a test procedure for determining the suitability of user equipment for use in an airplane with the airplanes' in-flight communications system. The method comprises the steps of determining an operator of said user equipment, verifying the user equipment suitability for use with the airplanes' communication system, and communicating this information to a database contained within the in-flight communication system.

### FIELD OF THE INVENTION

The present invention is related to a test procedure for user equipment in order to allow the usage of user equipment in an airplane for in-flight communication services.

User equipment includes any personal wireless communication apparatus that a user can utilize for applications such as, but not limited to, phone calls, web browsing, or e-mail services. Examples of possible user equipment are a UMTS phone, a GSM phone, or a WLAN card connected to a PC or PDA.

Identification numbers are often used to identify user equipment. The identification number is a non-transferable, unchangeable, unique number linked to the hardware of the user equipment. For example, in a GSM/UMTS mobile phone context the standard refers to the IMEI code, while for WLAN the standards refer to the MAC address.

### STATE OF THE ART

Today, while travelling on an airplane, during the safety briefing the airline companies are requesting you to switch off your user equipment for safety reasons. Therefore airline companies willing to offer communication services to their passengers have to install specific onboard phone/Ethernet connections. These services are often expensive and often limited to business and first class travellers.

Currently, some airline companies are willing to take a new approach. This new approach is about authorising more passengers to communicate using their own user equipment during a flight. One problem associated with this approach is related to the need to wire the whole cabin to allow all passengers to connect to the aircraft network. An interesting solution to this problem, which is currently being considered by the airline companies and aircraft manufacturers, is to use wireless communications inside the aircraft.

In order to allow the wireless access to the aircraft network, which is then linked to a communication service provider, airline companies and aircraft manufacturers will have to install a wireless access points inside the airplane cabin. An access point is a wireless device where user equipment can be connected through the same air interface. For some mobile phone standards the functionality of the access point can go up to a base station.

This wireless approach is lowering the installation cost, as fewer wires will need to be flight certified. The access point will then be connected through the aircraft network to an on-board service provider or a communication service provider, for example, by using a satellite link between the aircraft network and the communication service provider.

One of the major issues related to the use of user equipment in an aircraft environment is related to the EMC and EMI issues. Regulatory bodies, such as the FCC, FAA, and Eurocontrol, specify the criteria regarding the EMC and EMI certification of the equipment used in an airplane. Due to the high variety of models, brand diversity, and aging of the various type of user equipment currently available, it would be almost impossible to track which equipment is authorized for use in an airplane and which is not.

“Airborne Operation of Portable Electronic Devices” by CALCE Electronic Products and Systems Center, University of Maryland, gives an overview of the current FAA and FCC ruling related to the use of user equipment in an airplane.

The current FAA advisory circular AC 91.21-1 gives further information and guidance concerning the Federal Aviation Regulations on the use of portable electronic devices aboard aircraft.

Further challenges face the airline industry if the use of user equipment in an aircraft is to gain regulatory approval. One such challenge is related to the flight certification of the user equipment. As the quantity of different types existing user equipments is relatively high, a further challenge is the need to ensure that the user equipment is able to access the in-flight communication services. Furthermore, there is the need to manage the deterioration of the user equipment over time due to the aging effect on its components. Additionally, there is the need to ensure that unauthorized users are not able to pass by the on flight certification.

Finally, there is the need to develop user-friendly, ergonomic test equipment that can be operated by non-technical skilled persons for the test procedure of the user equipment. Such test equipment can be based on the Agilent Technologies, Inc. Momentum 8960 Series, which tests mobile phones for a variety of performance parameters, such as ACLR, out of band transmissions, transmitted power levels in the whole spectrum, and sensitivity tests.

### AIMS OF THE INVENTION

The object of the present invention is to provide a new concept on how user equipment could be tested prior to embarkation in order to be flight certified. The invention describes also the test aspects and procedures that need to be followed prior to embarkation, and how the aircraft onboard network can allow or reject user equipment.

### SUMMARY OF THE INVENTION

According to the present invention, such an object is achieved by means of a method and apparatus for testing user equipment, the method and apparatus having the features called for in the claims that follow.

### BRIEF DESCRIPTION OF THE DRAWINGS

FIG. 1 describes the process that, according to the present invention, a passenger needs to follow between check-in and boarding of an airplane,

FIG. 2 describes the process that, according to the present invention, a passenger must follow in order to start a communication in an airplane during flight,

FIG. 3 describes the different steps comprised in the test procedure according to the present invention, and

FIG. 4 describes a possible aircraft network configuration according to the present invention.

### DETAILED DESCRIPTION OF THE INVENTION

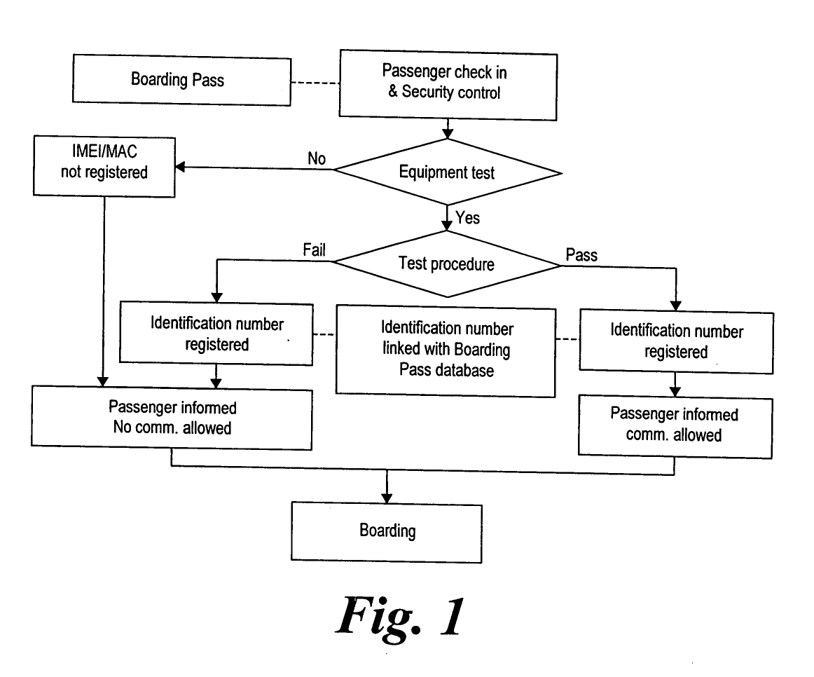

In FIG. 1 the process that the passenger will follow between the check-in and the boarding of the airplane is described. First during the check-in, a link is set in the carrier database between the passenger/user identity and the boarding card containing passenger name, the flight information, and seat.

After the security control, the user will be able to decide if he intends to test his equipment. This test could be time limited in order to avoid that a user can test his equipment a long period in advance, for example, a time limitation could be 2 hours prior to departure. On the other hand, in order to void that frequent travellers need to follow the test procedure every time, the airline companies could accept that the test performed by the frequent traveller has a longer validity, for example, 3 months. In that case, the airline company will, when the frequent flyer checked in, automatically update the database with the identification number of the frequent flyer.

If the user decides not to test his equipment, the identification number of his user equipment will not be registered in the carrier database. The user is therefore informed that he will not be allowed to use his user equipment for in-flight communication. The passenger can then proceed to boarding.

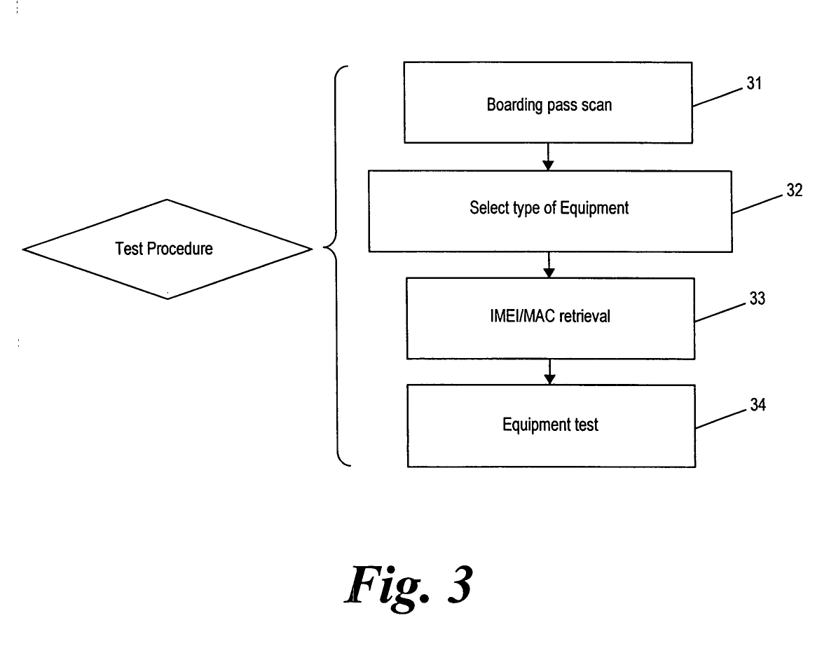

If the user decides to test his equipment, two possible results of the test, as explained further in FIG. 3, can be expected: Fail or Pass. If the test fails, the identification number of the user equipment, linked with the passenger ID is registered in the carrier database together with the information related to the test outcome (Fail). The passenger is then informed that his equipment has been tested and considered unsafe according to the carrier's safety rules. He will therefore not be allowed to communicate during flight with this user equipment. The passenger can proceeds to boarding.

If the user equipment has passed the test, the identification number of the user equipment, linked with the passenger ID is registered in the database together with the information related to the test outcomes (Pass). The passenger is then informed that his equipment is tested and found safe and that he will be allowed to communicate during flight with this device. The passenger proceeds to boarding.

After the test procedure is finished, the test machine will transfer to the database at least the following information: Passenger ID, identification number of the user equipment, result of the test for each piece of equipment tested. The information will then be used to determine which user equipment is allowed connection to the aircraft network during the flight.

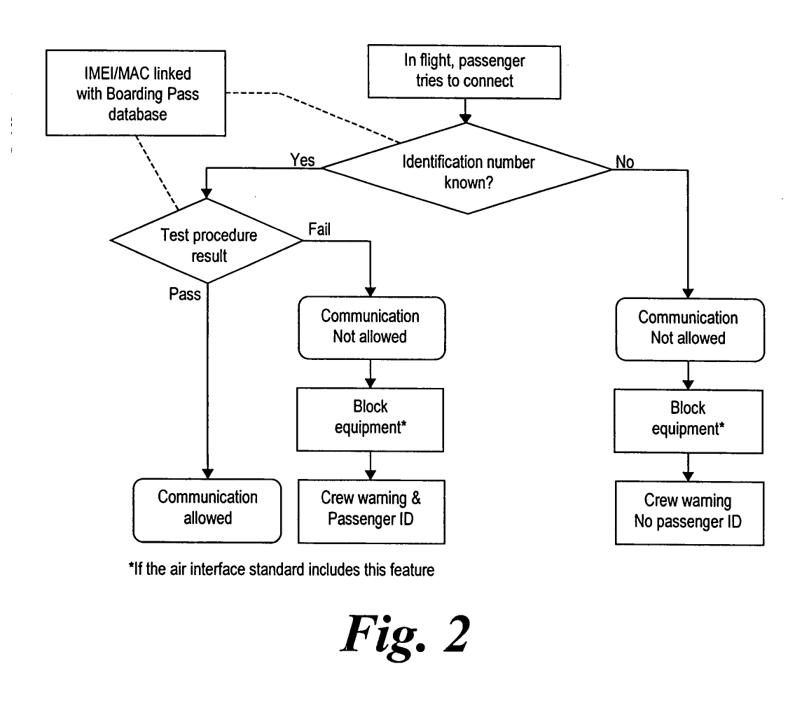

FIG. 2 describes the process of a passenger wanting to start a communication in a plane during flight. By switching on his user equipment, the passenger will start the connection between his user equipment and the aircraft network. The aircraft network will retrieve the identification number of the user equipment and compare it with the accepted and rejected identification number present in the database. The procedure related to the request from the aircraft network to the user equipment is explained in more detail in FIG. 5. If the user intends to connect with a device that has passed the test procedure, as described in FIG. 1, the aircraft network will retrieve the identification number of the user equipment and find in the database that the test result passed. The aircraft network will therefore allow the connection between the user equipment and the service provider trough the access point in the plane. This communication could be subject to further restriction on the service delivery imposed by the airline companies, for example, requiring a subscription to the service. Further use of the identification number could be to help the carrier or the service provider to bill their passenger based on the data traffic they generated or requested. If the users intend to connect with a device that failed during the test or that was not tested, the aircraft network will reject the connection of the user equipment with the service provider. If the air interface standard allows it, the aircraft network will be able to block the user equipment transmission in order to avoid spurious and other EMC problems. For example, UMTS allow the blocking of RACH transmission for a non-authorized cell phone. The aircraft network can optionally, if blocking the user equipment electronically is not possible through the air interface, warn the airplane crew about a user wanting to connect to the aircraft network with non-authorized user equipment. If the identification number of the user equipment is known in the database due to it having failed the test, the aircraft network will be able to tell the crew which person (including his seat location) is trying to connect to the aircraft network.

FIG. 3 describes the different steps included in the test procedure. The test procedure will include, but is not limited to, four different steps. The first step 31 that the passenger needs to execute is scanning his boarding pass in order to activate the test procedure. By scanning his boarding pass, the test machine will be able to access the passenger information such as: passenger ID, flight information, and seat information. The second step 32 will be a request from the test machine to the passenger in order to identify the type of air interface the user equipment is using. The test machine only requests air interfaces that are flight approved, leaving the passenger the choice to select one or more (in case of a multi-mode user equipment) available air interface he want to use for in-flight communication. As the test machine is connected to the flight information of the passenger, the test machine is able to select the air interface available on the aircraft network. This step could be suppressed if the machine is able to automatically identify the user equipment or if only one type of air interface is accepted on-board.

After the selection of the correct air interface, the test machine will start by retrieving the identification number of the user equipment 33. The identification number is saved in the test machine during the test procedure. Later, when the test is finished, the test machine will communicate to the database the identification number, as described in FIG. 1, in order to link the user equipment with a test result for future use when the passenger request an in-flight connection, as per FIG. 2.

The final step 34 of the test procedure is related to testing the air interface from the user equipment. The main purpose of this test is to make sure that the user equipment transmission and reception circuits will not disturb the aircraft systems. The user equipment transmission could, for example, interfere with the aircraft system by transmitting signals outside the operation or at too high power levels. The receiver of the user equipment can be optionally tested as well. It is clear that the receiver as such will not interfere with the aircraft system.

However, the user equipment as an “entity” needs to be tested in a realistic communication scenario. This optional receiver test will allow the detection of possible EMC/EMI emission coming from other components not directly related to the air interface, such as a microprocessor. The optional receiver test can also insure that the terminal sensitivity will be high enough to receive correctly the wireless onboard services. Based on the aircraft regulation, such as FAA FAR 91.21 regarding the allowed on board EMC/EMI levels, the test equipment will start automatic testing different relevant parameters, such as but not limited to: ACLR, out of band transmissions, transmitted power levels in the whole spectrum, and sensitivity test.

As an example, for a UMTS cell phone, the test machine could test the following parameters: thermal power, channel power, adjacent channel leakage and the waveform quality. For the waveform quality this can include: error vector magnitude, frequency error, phase error, magnitude error, and origin offset.

Such test machine presented in this concept could be a simplified user-friendly version of the Agilent Technologies 8960 Series 10 (“Momentum”) test equipment.

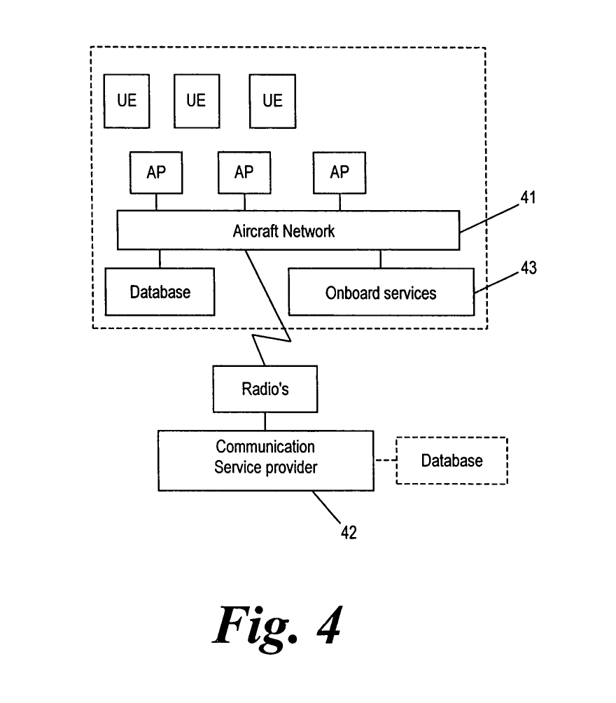

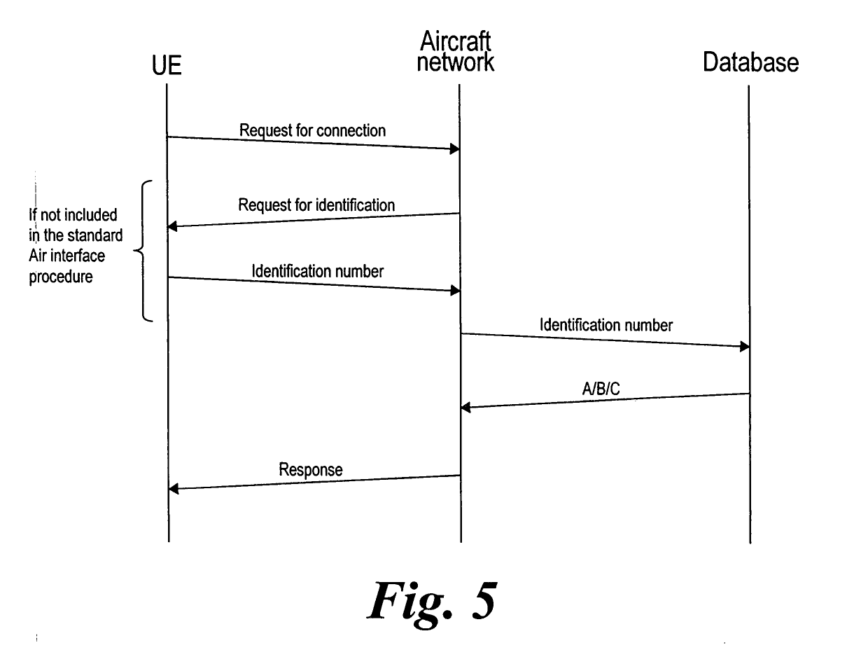

FIG. 4 describes how a possible aircraft network could look like. Typically the aircraft network will be composed of user equipments (UE) owned by the passenger or rented from the airline companies; some access points (AP) (at least one) mounted in the airplane acting as a kind of wireless base station; an aircraft network (41) being a central interconnection equipment between the different access points, the communication service provider (42) perhaps through a satellite link, and onboard services (43). The aircraft network can also be connected or directly or through the communication service provider to the database containing the authorized and unauthorized users. A direct connection between the aircraft network and the database has the advantage of faster processing of the request for connection. Such database could be integrated together with other software related to the aircraft network. If the database is located on the airplane its contents should be updated with the new passenger data prior to departure or through the connection of the database with the information system of the airline company.

FIG. 5 explains how the aircraft network will only allow accepted user equipment to connect to the aircraft network. This procedure can be a preliminary procedure to a service subscription procedure. The user equipment that is switched on initiates the first step. In most of the air interface standards, the user equipment automatically initiates a request for connection (or registration) to the network, for example, in UMTS the RACH channel. When the aircraft network detects the request for connection, depending on the air interface used, if the identification number is not transmitted, the network will request the user equipment to transmit its identification number. If this is not done, the user equipment transmits his identification number to the aircraft network. The aircraft network transmits the identification number to the database. The database replies to the request from the aircraft network with the three possible messages: A, B, or C, where

A=identification number unknown;

B=identification number known, passenger ID, test result=failed; and

C=identification number known, passenger ID, test result=passed.

In case A, the aircraft network response will deny access to the aircraft network and, depending on the air interface used, try to block the transmission of the user equipment. The aircraft network is also able to warn the cabin crew of an unauthorized attempt to connect to the aircraft network.

In case B, like case A, the aircraft network will depending on the air interface try to block the user equipment, warn the cabin crew, but include information on the passenger trying to attempt to connect an unauthorized user equipment to the aircraft network.

In case C, the aircraft network will proceed with the subscription of the user equipment in order to connect it to the service provider or the on-board services.

As will be appreciated by the skilled person, switching and interchanging some of the steps in the method described above can achieve the same results. It is clear that the ideas behind how this method is used including the results are the core of the invention. It is not intended that the present invention be limited to the above embodiments and other modifications and variations are envisaged within the scope of the claims.

### Abbreviation List:

ACLR: Adjacent Channel Leakage Power Ratio

AP: Access Point

EMC: Electromagnetic Compatibility

EMI: Electromagnetic Interference

FAA: Federal Aviation Authorities

FCC: Federal Communications Commission (USA)

GSM: Global System for Mobile Communication

IMEI: International Mobile Equipment Identification

MAC: Machine Address Code

PC: Personal Computer

PDA: Personal Digital Assistant

UE: User Equipment

UMTS: Universal Mobile Telecommunications System

WLAN: Wireless Local Area Network

1. A method of testing user equipment for operational suitability with an in-flight communication system, the method comprising the steps of:
identifying an operator of said user equipment,
testing said user equipment for a set of predetermined parameters,
comparing said test results with a predefined criteria to determine a Pass or Fail status of said user equipment,
communicating said Pass or Fail status and said operator identity to said in-flight communication system.

2. A method as claimed in claim 1, wherein said user equipment is a mobile phone.

3. A method as claims in claim 2, wherein said set of predetermined parameters includes user equipment power level.

4. A method as claimed in claim 1, wherein the set of predefined parameters includes at least one of adjacent channel leakage and waveform quality.
